(19) United States
(12) Patent Application Publication
(10) Pub. No.: US 2018/0223403 A1
(43) Pub. Date: Aug. 9, 2018

(54) HIGH-ALLOY STEEL AND METHOD FOR PRODUCING PIPES FROM THIS STEEL BY MEANS OF INTERNAL HIGH PRESSURE FORMING

(71) Applicant: Salzgitter Flachstahl GmbH, 38239 Salzgitter (DE)

(72) Inventors: THOMAS Evertz, Peine (DE); ALEXANDER REDENIUS, Braunschweig (DE); MANUEL OTTO, Cremlingen (DE); PETER PALZER, Liebenburg (DE)

(73) Assignee: Salzgitter Flachstahl GmbH, 38239 Salzgitter (DE)

(21) Appl. No.: 15/748,057

(22) PCT Filed: Jul. 26, 2016
(86) PCT No.: PCT/EP2016/067824

§ 371 Date: Jan. 26, 2018

(30) Foreign Application Priority Data
Jul. 27, 2015 (DE) 10 2015 112 215.4

(51) Int. Cl. C22C 38/58; C22C 38/00; B21D 26/053; B21D 26/033; C21D 6/00; C21D 7/12; C21D 8/10; C21D 9/08

(52) U.S. Cl. CPC C22C 38/58; C22C 38/001; B21D 26/053; B21D 26/033; C21D 6/005; B23K 2201/06; C21D 7/12; C21D 8/105; C21D 9/08; C21D 2211/001; C21D 6/004

(57) ABSTRACT

The invention relates to a high-alloy steel, in particular for producing pipes shaped by means of internal high pressure, having high cold formability, TRIP and/or TWIP properties, a partially or completely austenitic microstructure having at least 5% residual austenite, and having the following chemical composition (in wt %): Cr: 7 to 20; Mn: 2 to 9; Ni: up to 9; C: 0.005 to 0.4; N: 0.002 to 0.3; the remainder being iron including unavoidable, steel-accompanying elements, with optional addition of the following elements (in wt %): Al: 0 to 3; Si: 0 to 2; Mo: 0.01 to 3; Cu: 0.005 to 4; V: 0 to 2; Nb: 0 to 2; Ti: 0 to 2; Sb: 0 to 0.5; B: 0 to 0.5; Co: 0 to 5; W: 0 to 3; Zr: 0 to 2; Ca: 0 to 0.1; P: 0 to 0.6; S: 0 to 0.2. The invention further relates to a method for producing pipes from this steel, said pipes being shaped by means of internal high pressure.

The invention relates to a high-alloy steel, in particular for producing pipes formed by means of internal high pressure (IHF), having TRIP and/or TWIP properties and a partially or completely austenitic microstructure with at least 5% residual austenite and a method for producing IHF pipes from this steel.

High-alloy steels are understood hereinafter to be steels which have been alloyed e.g. with chromium, nickel and possibly further alloy elements in order to improve the corrosion properties and/or cold deformability. 1.4301 (X5CrNi18-10) steel or 1.4618 (X9CrMnNiCu17-8-5-2) steel can be named as examples of such steels. These steels have substantially an austenitic microstructure.

Internal high pressure forming of pipes has been known for a long time and is described in detail e.g. in laid-open document DE 10 2008 014 213 A1. In this case, the workpieces are produced from a pipe-shaped hollow profile blank which is inserted into an at least two-part tool having the finished workpiece geometry, such that the hollow profile blank is subjected on the inner side to a high fluid pressure and is expanded into the engraving or geometry of the tool. The material must be configured such that the high deformations can be absorbed without material failure.

The use of rust-proof, high-grade steels to produce pipes formed by internal high pressure is described in the utility model document DE 296 12 387 U1 This document does not disclose a specific alloy composition of the steel used.

Known high-alloy steels, such as e.g. 1.4301 steel, which basically can also be used for producing pipes formed by internal high pressure, have the disadvantage that the steel is relatively expensive by reason of the high Ni content and in some cases the cold deformability of the material is not yet sufficiently high in the case of internal high pressure forming.

Although 1.4618 steel has improved cold deformability by reason of the alloying of copper, the production of cold strips from the known steels by the known production route of continuous casting, hot rolling, cold rolling with intermediate annealing, moulding the cold strip into a slotted pipe, welding the pipe is very expensive and therefore uneconomical.

Against this background of the described prior art, it was the object of the invention to provide a cost-effective high-alloy steel having high cold deformability, in particular for producing pipes formed by means of internal high pressure (IHF pipes), and to provide a cost-effective method for producing IHF pipes from this steel.

A high-alloy steel in accordance with the invention is described in greater detail in claim 1 and dependent claims 2 to 18. Essential components of the steel with a C content of 0.005 to 0.4 wt. % and an N content of 0.002 to 0.3 wt. %, are in particular a high Cr content of 7 to 20 wt. % and Mn content of 2 to 9 wt.%.

The use of the term to or up to in the definition of the content ranges, such as e.g. 7 to 20 wt. %, means that the limit values—7 and 20 in the example—are also included.

In accordance with the invention, in the case of this material the temperature-dependent TRIP (Transformation Induced Plasticity) or TWIP (Twinning Induced Plasticity) effect is utilised and facilitates an enormous increase in the cold deformability of the steel during internal high pressure forming of the pipe. These effects occur in high-alloy austenitic steels or steels having a high manganese content and are characterised during plastic deformation of the steel by the formation of deformation martensite (TRIP effect) or by twinning during deformation (TWIP effect).

The material used for producing the IHF pipes is characterised, depending upon the specific alloy composition, by a partially or completely austenitic microstructure having at least 5% residual austenite which, in accordance with the invention, produces a TWIP and/or TRIP effect during mechanical loading.

Advantageous alloy compositions of the steel used for producing pipes are described in claims 2 to 18.

An alloy as claimed in claim 2 forms, by reason of the Cr content of at least 10 wt. %, a dense oxide layer on the surface, wherein, in the case of the steels in accordance with the invention with Cr contents of greater than 18 wt. %, the effect of the oxide layer protecting against corrosion is not appreciably increased. A nickel proportion of 2 to 6 wt. % stabilises the austenite to the extent that an at least part-austenitic microstructure is produced which produces a TRIP/TWIP effect in the event of mechanical stresses.

Contents of over 6 wt. % Ni result in further stabilisation of austenite, which is at the expense of the proportion of ferrite and martensite in the microstructure and therefore impairs the strength properties of the material.

An alloy as claimed in claim 3 forms, by reason of its Cr content of at least 12 wt. %, a dense oxide layer, wherein higher contents of impurities and carbides can be tolerated in comparison with an alloy as claimed in claim 2. Contents above 17 wt. % Cr reduce the expansion properties and do not provide any advantage for the steel in accordance with the invention.

An alloy as claimed in claim 4 has an Mn content of 2 to 7 wt. %. Manganese increases the austenite stability and thus provides an at least partially austenitic microstructure which produces a TRIP/TWIP effect in the event of mechanical stresses. In order to achieve a corresponding effect, the minimum content of manganese is 2 wt. %. Mn contents above 7 wt. % increase the susceptibility to pitting corrosion, for which reason the content in the alloy in accordance with the invention is advantageously restricted to a maximum of 7 wt. %.

An alloy as claimed in claim 5 contains between 0.5 and 5 wt. % Ni. Nickel is used as an element which stabilises austenite and provides an at least partially austenitic microstructure which produces a TRIP/TWIP effect in the event of mechanical stresses. Furthermore, Ni improves the resistance to pitting corrosion and increases the strength of the material. In order to achieve a corresponding effect, the minimum content of nickel is therefore 0.5 wt. %. Contents above 5 wt. % result not only in increased alloy costs but also in increased austenite stability which is undesired by reason of the reduction in the ferrite and martensite proportions in the microstructure and the associated decrease in strength.

An alloy as claimed in claim 6 contains at least one of the elements V, Nb and/or Mo having a minimum content of 0.005 wt. % for the individual element and a maximum content of <5 wt.% in total. In the steel, these elements act as carbide, nitride or carbonitride forming agents and thereby provide stabilisation with respect to ageing through the removal of the elements C and N and, associated therewith, also provide solidification by precipitation formation, as well as grain refinement and the associated increase in strength and toughness. In order to achieve a corresponding effect, a minimum content for the individual element of 0.005 wt. % is necessary. Contents starting from: 5 wt. % in total result, in the case of higher carbon contents, in the precipitation of large quantities of carbides and impair the properties of the alloy. Furthermore, no further improvement in the properties is to be expected from contents of 5 wt. % or more in total.

An alloy as claimed in claim 7 contains between 0.005 and 2 wt. % Ti and has a maximum content of N of less than 300 ppm. Titanium acts as a carbide forming agent and provides grain refinement, whereby at the same time the strength and toughness properties are improved. In order to achieve a corresponding effect, a minimum content of Ti of 0.005 wt. % is necessary. Contents of Ti over 2 wt. % do not provide any further improvement in the properties. In the case of these alloys, the N content is limited to less than 300 ppm in order to minimise the formation of undesired TiN precipitations.

An alloy as claimed in claim 8 contains between 0.05 and 3 wt. % Al and has an N content of less than 300 ppm. Aluminium brings about not only a deoxidation of the melt but also a reduction in the specific density and improves the corrosion properties. Furthermore, Al improves the strength of the alloy in accordance with the invention. In order to achieve a corresponding effect, a minimum content of Al of 0.05 wt. % is necessary. Contents of over 3 wt. % Al can result in the precipitation of undesired phases. The N content is limited to less than 300 ppm in order to reduce the undesired precipitation of needle-shaped AlN.

An alloy as claimed in claim 9 contains 0.03 to 2 wt. % Si. In this case, silicon has a deoxidising effect, lowers the specific density and increases the strength of the alloy in accordance with the invention. In order to achieve a corresponding effect, a minimum content of Si of 0.03 wt. % is necessary. Contents of over 2 wt. % Si reduce the expansion properties and reduce the deformability of the alloy in accordance with the invention.

An alloy as claimed in claim 10 contains between 0.05 and 4 wt. % Cu. Copper improves the corrosion and strength properties of the alloy in accordance with the invention. In order to achieve a corresponding effect, a minimum content of Cu of 0.05 wt. % is necessary. Contents of over 4 wt. % Cu impair the processability of the material through the formation of low-melting phases during hot deformation or casting and do not result in any further improvements in properties.

An alloy as claimed in claim 11 contains between 0.005 and 0.5 wt. % Sb. Antimony reduces the C, N, O and Al diffusion, whereby particularly carbides, nitrides and carbonitrides are more finely precipitated. This improves the effective utilisation of these alloy elements, which increases economic feasibility and reduces the consumption of resources, as well as the strength, expansion and toughness properties. In order to achieve the effect in accordance with the invention, an Sb content of at least 0.005 wt. % is necessary. Contents above 0.5 wt. % result in the undesired precipitation of Sb at the grain boundaries and thus results in the impairment of the expansion and toughness properties.

An alloy as claimed in claim 12 contains 0.0002 to 0.5 wt. % B. Boron brings about an improvement in the strength properties and the edge quality of rolled hot strip even from a small addition of 0.0002 wt. %. Contents above 0.5 wt. % greatly impair the toughness and expansion properties of the alloy in accordance with the invention.

An alloy as claimed in claim 13 contains between 0.05 and 5 wt. % Co. Cobalt stabilises the austenite and improves the heat resistance. In order to achieve a corresponding effect, a minimum content of 0.05 wt. % is necessary. The maximum content is limited to 5 wt. % because higher Co contents impair the expansion properties and in addition stabilise the austenite undesirably, whereby the ferrite and martensite content and, associated therewith, the strength properties decrease.

An alloy as claimed in claim 14 contains between 0.005 and 3 wt. % W. Tungsten acts as a carbide forming agent and improves the strength and heat resistance. In order to achieve a corresponding effect, a minimum content of 0.005 wt. % is necessary. Contents of more than 3 wt. % W impair the expansion properties in the alloy in accordance with the invention.

An alloy as claimed in claim 15 contains between 0.005 and 2 wt. % Zr. Zirconium acts as a carbide forming agent and improves the strength of the alloy in accordance with the invention. In order to achieve a corresponding effect, a minimum content of 0.005 wt. % is necessary. Contents of more than 2 wt. % impair the expansion properties of the alloy in accordance with the invention.

An alloy as claimed in claim 16 contains between 0.0005 and 0.1 wt. % Ca. Calcium is used for modifying non-metallic oxidic inclusions which could otherwise result in the undesired failure of the alloy as a result of inclusions in the microstructure which act as stress concentration points and weaken the metal composite.

Furthermore, Ca improves the homogeneity of the alloy in accordance with the invention. In order to achieve a corresponding effect, a minimum content of 0.0005 wt. % is necessary, Contents of above 0.1 wt. % Ca do not provide any further advantage in the modification of inclusions, impair producibility and should be avoided by reason of the high vapour pressure of Ca in steel melts.

An alloy as claimed in claim 17 contains between 0.008 and 0.6 wt. % P. Phosphorous increases the elasticity limit and improves the corrosion resistance to atmospheric influences. In order to achieve a corresponding effect, a minimum content of 0.008 wt. % is necessary. Contents of more than 0.6 wt. % P impair the expansion properties of the alloy in accordance with the invention.

An alloy as claimed in claim 18 contains between 0.01 and 0.2 wt. % S. Sulphur improves the machining capability. In order to achieve a corresponding effect, a minimum content of 0.01 wt. % is necessary. Contents of over 0.2 wt. % S result in the undesired precipitation of MnS and in significant impairment of the toughness and expansion properties of the alloy in accordance with the invention.

The above-described steel is suitable particularly for producing pipes formed by internal high pressure.

A production method in accordance with the invention for producing pipes formed by means of internal high pressure from the steel in accordance with the invention is provided by the working steps of:
smelting a steel melt with the following chemical composition (in wt. %):
Cr: 7 to 20
Mn: 2 to 9
Ni: up to 9
C: 0.005 to 0.4
N: 0.002 to 0.3
with the remainder being iron and unavoidable, steel-associated elements, with optional alloying of the following elements (in wt. %):
Al: 0 to 3
Si: 0 to 2
Mo: 0.01 to 3
Cu: 0.005 to 4
V: 0 to 2
Nb: 0 to 2
Ti: 0 to 2
Sb: 0 to 0.5
B: 0 to 0.5
Co: 0 to 5
W: 0 to 3
Zr: 0 to 2
Ca: 0 to 0.1
P: 0 to 0.6
S: 0 to 0.2
producing a pre-strip by means of a horizontal or vertical casting process approximating the final dimensions or producing slabs by means of a horizontal or vertical slap or thin slab casting process,
producing a hot strip by hot rolling the pre-strip with a thickness greater than or equal to 2 mm or by hot rolling the slab,
optionally cold rolling the hot strip or cold rolling the pre-strip with a thickness less than 2 mm.
moulding the hot strip or cold strip and welding it to form a pipe, and
internal high pressure forming of the pipe by means of an active medium and the active medium has been tempered to above room temperature (RT) to 500° C.

In the case of the method in accordance with the invention, an alloy in accordance with the invention is produced by means of a casting process approximating the final dimensions or a conventional continuous casting process and subsequently is hot-rolled and/or cold-rolled. The hot strip or cold strip produced in this way is then moulded and joined to form a pipe e.g. by means of high frequency induction welding or laser welding. However, other joining processes which are established for the production of pipes can also be used, such as e.g. submerged arc welding or metal protective gas welding.

The pipe is then subjected to internal high pressure forming (IHF), wherein during the internal high pressure forming process, the active medium is tempered to a temperature above RT to about 500° C., which produces a further significant increase in the deformability of the steel in accordance with the invention. The temperature of the active medium is advantageously 40 to 300° C., wherein the optimum range is 80 to 240° C.

Tempering the medium serves to increase the stability and stacking fault energy of the austenite, whereby the stress-induced martensite conversion is suppressed and the TWIP effect is preferred. Therefore, the deformability of the material is considerably improved with respect to deformation at room temperature.

This improvement in the deformation properties also renders it possible for annealing processes which are otherwise necessarily upstream of the internal high pressure forming process can be shortened or omitted, whereby the energy requirement and, associated therewith, the costs of producing an IHF pipe from this material are considerably reduced.

In an advantageous manner, it is possible to omit a heat treatment of the pipe for improving the deformability by means of internal high pressure forming or prior to the internal high pressure forming process, if degrees of deformation of less than 80% are set for the production of the hot strip or cold strip.

In the case of higher degrees of deformation, a then possibly necessary heat treatment can be performed in an advantageous manner directly after the pipe moulding and longitudinal seam welding process, wherein the heat treatment can be performed in a continuous furnace or in a stationary furnace unit (e.g. hearth furnace, muffle furnace) or by means of the tempered active medium per se. The temperature for the heat treatment is between 80° C. and 0.9*TS (melting temperature of the respective alloy in ° C.).

Basically, possible casting processes approximating the final dimensions include horizontal strip casting and vertical strip casting (e.g. two roller strip casting). Strip thicknesses of the pre-strip of about 1 to 30 mm, advantageously 1 to 20 mm, are produced thereby.

In an advantageous manner, the strip casting is performed in an inertising or reducing or slightly oxidising atmosphere having an oxygen proportion of under 10 vol. %. As a result, segregations and selective oxidation and therefore hot cracks are significantly reduced during hot rolling.

The pre-strip which is produced by casting processes approximating the final dimensions or the slab is then hot-rolled, wherein the hot rolling starting temperature is at least 900 to 1200° C. and the end rolling temperature is at least 650° C. In accordance with the invention, the pre-strip produced approximating the final dimensions is hot-rolled with a maximum of 6 rolling passes, advantageously with 2 to 4 rolling passes. Subsequently, the hot-strip is wound up into a coil and is either further processed directly to form a pipe or it is further processed as a cold-rolled strip.

Alternatively, e.g. in the case of short pipe lengths, sheets can also be cut from the wound-up hot strip or cold strip and subsequently can be further processed.

In the case of pre-strip thicknesses under 2 mm, a hot rolling process can be omitted by reason of the low degree of deformation. Instead, the strip is subjected directly to a cold rolling process.

Typically, after the rolling process thicknesses of 1.5 mm to 15 mm are achieved for the hot strip and thicknesses of 0.2 to 12 mm are achieved for the cold-rolled strip.

1-28. (canceled)

29. A high-alloy steel, in particular for producing pipes formed by means of internal high pressure, having high cold deformability, having TRIP and/or TWIP properties, having a partially or completely austenitic microstructure with at least 5% residual austenite, said high-ally steel comprising a chemical composition comprising in wt. %:
Cr: 7 to 20
Mn: 2 to 9
Ni: up to 9
C: 0.005 to 0.4
N: 0.002 to 0.3
with the remainder being iron and unavoidable, steel-associated elements.

30. The steel of claim 29, further comprising at least one alloy element in wt. % selected from the group consisting of:
Al: 0 to 3
Si: 0 to 2
Mo: 0.01 to 3
Cu: 0.005 to 4
V: 0 to 2
Nb: 0 to 2
Ti: 0 to 2
Sb: 0 to 0.5
B: 0 to 0.5
Co: 0 to 5
W: 0 to 3
Zr: 0 to 2
Ca: 0 to 0.1
P: 0 to 0.6
S: 0 to 0.2.

31. The steel of claim 29, wherein a content of Cr is 10 to 18, and a content of Ni is 2 to 6.

32. The steel of claim 29, wherein a Cr content is 12 to 17 wt. %.

33. The steel of claim 29, wherein a Mn content is 2 to 7 wt. %.

34. The steel of claim 29, wherein a Ni content is 0.5 to 5 wt. %.

35. The steel of claim 29, wherein the steel further contains at least one alloy element in wt. % selected from the group consisting of V, Nb and Mo having a minimum content of 0.005 wt. %, wherein a total of the alloy elements V, Nb and Mo is <5 wt. %.

36. The steel of claim 29, wherein the steel further contains 0.005 to 2 wt. % Ti, with a content of N being <300 ppm.

37. The steel of claim 29, wherein the steel further contains 0.05 to 3 wt. % Al, with a content of N being <300 ppm.

38. The steel of claim 29, wherein the steel further contains 0.03 to 2 wt. % Si.

39. The steel of claim 29, wherein the steel further contains 0.05 to 4 wt. % Cu.

40. The steel of claim 29, wherein the steel further contains 0.005 to 0.5 wt. % Sb.

41. The steel of claim 29, wherein the steel further contains 0.0002 to 0.5 wt. % B.

42. The steel of claim 29, wherein the steel further contains 0.05 to 5 wt. % Co.

43. The steel of claim 29, wherein the steel further contains 0.005 to 3 wt. % W.

44. The steel of claim 29, wherein the steel further contains 0.005 to 2 wt. % Zr.

45. The steel of claim 29, wherein the steel further contains 0.0005 to 0.1 wt. % Ca.

46. The steel of claim 29, wherein the steel further contains 0.008 to 0.6 wt. % P.

47. The steel of claim 29, wherein the steel further contains 0.01 to 0.2 wt. % S.

48. The steel of claim 29 for producing a pipe by internal high pressure.

49. A method for producing a pipe by internal high pressure, said method comprising:
smelting a steel melt having a chemical composition comprising in wt. %:
Cr: 7 to 20
Mn: 2 to 9
Ni: up to 9
C: 0.005 to 0.4
N: 0.002 to 0.3,
with the remainder being iron and unavoidable, steel-associated elements;
producing a pre-strip by a horizontal or vertical casting process approximating a final dimension or producing a slab by a horizontal or vertical slap or thin slab casting process;
producing a hot strip by hot rolling the pre-strip with a thickness greater than or equal to 2 mm or by hot rolling the slab;
optionally cold rolling the hot strip or cold rolling the pre-strip with a thickness less than 2 mm;
moulding the hot strip or cold strip and welding it to form a pipe; and
internal high pressure forming of the pipe using an active medium, with the active medium having been tempered to above room temperature (RT) to 500° C.

50. The method of claim 49, wherein the steel contains at least one alloy element in wt. % selected from the group consisting of:
Al: 0 to 3
Si: 0 to 2
Mo: 0.01 to 3
Cu: 0.005 to 4
V: 0 to 2
Nb: 0 to 2
Ti: 0 to 2
Sb: 0 to 0.5
B: 0 to 0.5
Co: 0 to 5
W: 0 to 3
Zr: 0 to 2
Ca: 0 to 0.1
P: 0 to 0.6
S: 0 to 0.2.

51. The method of claim 49, wherein the casting process approximating the final dimension is a horizontal strip casting or vertical strip casting process to produce the pre-strip with a strip thickness of 1 to 30 mm, advantageously 1 to 20 mm.

52. The method of claim 49, wherein the cast pre-strip or the slab is hot-rolled at a hot rolling starting temperature of at least 900 to 1200° C. and an end rolling temperature of at least 650° C.

53. The method of claim 49, wherein the pre-strip produced approximating the final dimension is hot-rolled with a maximum of 6 rolling passes, advantageously with 2 to 4 rolling passes.

54. The method of claim 49, further comprising:
unwinding the hot-rolled strip or cold-roiled strip from a coil; and
cutting the hot-rolled strip or cold-rolled strip into sheets.

55. The method of claim 49, wherein, after the rolling process the hot strip has a thickness of 1.5 mm to 15 mm and the cold-rolled strip has a thickness of 0.2 to 12 mm.

56. The method of claim 49, wherein the active medium has been tempered to a temperature of 40 to 300° C.

57. The method of claim 49, wherein the active medium has been tempered to a temperature of 80 to 240° C.

58. The method of claim 49, wherein the pipe is welded by high frequency induction welding or laser welding.
